(19) United States
(12) Patent Application Publication
(10) Pub. No.: US 2015/0275049 A1
(43) Pub. Date: Oct. 1, 2015

(54) Art Glass Peel and Stick Pattern Paper

(71) Applicant: Ruth Angie Stephens, Monte Sereno, CA (US)

(72) Inventor: Ruth Angie Stephens, Monte Sereno, CA (US)

(21) Appl. No.: 14/242,144

(22) Filed: Apr. 1, 2014

(51) Int. Cl. C09J 7/02; B44F 3/00

(52) U.S. Cl. CPC C09J 7/0232; B44F 3/00

(57) ABSTRACT

“Peel and Stick” pattern paper technology not only makes the pattern-making process more accurate—it's also faster, more flexible, and easier-to-use than traditional, grease pencil, Sharpie, double-sided tape, and paste or spray glue on paper techniques.

The Pattern System reduces the annoying and repetitive work of replacing pattern pieces back-on the glass (which can come off during the rigors of cutting, grinding, or sawing processes). The Pattern System also prevents the pattern from getting too moist—a common problem with the standard techniques. Moisture from the grinder (and/or the saw) typically misaligns and even warps the pattern, which means the disappointment of starting from scratch, redoing the pattern piece over again to ensure precision assembly.

### CROSS REFERENCE TO RELATED APPLICATION

Provisional Patent Number 61/855,200 Filed on May 11, 2013

This application claims priority to U.S. Provisional Application No. 61/855,200, entitled ART GLASS ‘PEEL AND STICK’ PATTERN PAPER filed May 11, 2013, which is incorporated herein by reference for all purposes.

### BACKGROUND OF INVENTION

Stained Glass window construction and Stained Glass kiln fusing is becoming increasingly popular among professionals, novices and enthusiasts. Using traditional methods to transfer the pattern design to the glass for cutting and grinding guide lines has been a difficult task in order to maintain the extreme precision required to ensure successful integrity for the accurate fittings required for construction.

In some embodiments, specifically designed for Art Glass Artist's, this versatile ‘Peel and Stick’ Pattern Paper produces accurate results in pattern transferring and glass cutting. In some embodiments, it offers durability in pattern shape integrity, water and tear resistant stability . . . all with the ease and convenience of ‘Peel and Stick’ technology.

### BRIEF DESCRIPTION OF THE DRAWINGS

FIG. 1A & 1B: Illustrates an example of ‘Peel and Stick’ pattern paper in roll or sheet format in accordance with some embodiments.

FIG. 2: Shows Art Glass pattern system components in accordance with some embodiments.

FIG. 3: Shows design and transfer paper on ‘Peel and Stick’ pattern paper in accordance with some embodiments.

FIG. 4: Shows tracing to transfer design to ‘Peel and Stick’ pattern paper in accordance with some embodiments.

FIG. 5: Shows checking to determine if a successful transfer to the ‘Peel and Stick’ pattern paper occurred in accordance with some embodiments.

FIG. 6: Shows entire design transferred to ‘Peel and Stick’ pattern paper in accordance with some embodiments.

FIG. 7: Shows numbering of pattern pieces and cutting them out of the ‘Peel and Stick’ pattern paper in accordance with some embodiments.

FIG. 8: Shows peeling off film-backing from adhesive side of ‘Peel and Stick’ pattern paper in accordance with some embodiments.

FIG. 9: Shows adhesive backed ‘Peel and Stick’ pattern paper stuck on glass with glass cutter, cutting around ‘Peel and Stick’ pattern paper in accordance with some embodiments.

FIG. 10: Shows grinding glass up-to the ‘Peel and Stick’ pattern paper edge in accordance with some embodiments

FIG. 11: Shows peeling ‘Peel and Stick’ pattern paper from cut glass piece in accordance with some embodiments.

FIG. 12: Shows cut glass piece placement on design original to repeat FIGS. 7 through 11 on all ‘Peel and Stick’ pattern paper pieces in accordance with some embodiments.

FIG. 13: Shows all glass design pieces fitting together prior to adding copper foil or lead came in accordance with some embodiments.

FIG. 14: Shows all glass design pieces edged with copper foil tape (a base for solder) in accordance with some embodiments.

FIG. 15: Shows finished project/window with lead solder applied to copper foil of completed project in accordance with some embodiments.

### SUMMARY OF INVENTION:

Finally, a remarkable, easy-to-use ‘Peel and Stick’ Pattern Paper and System that delivers the ultimate precision to various types of Art Glass construction projects including (but not limited to), for example, the following:
Lead Came Stained Glass Window Construction Projects;
Copper Foil Stained Glass Window Construction Projects;
Kiln Fused Glass Projects; and/or
Glass Mosaic Projects.

In some embodiments, specifically designed for Art Glass Artist's, this versatile ‘Peel and Stick’ Pattern Paper produces accurate results in pattern transferring and glass cutting. In some embodiments, it offers durability in pattern shape integrity, water and tear resistant stability . . . all with the ease and convenience of ‘Peel and Stick’ technology. Various embodiments are described below.

### White Polypropylene Film 9 mil, Adhesive-Backed ‘Peel and Stick’ Pattern Paper:

1. Macro porous coated adhesive backed top half, for example, of 9 mil, and 180 gram polypropylene film paper, peel-off backing.

### Available in various sheet and roll sizes, standard sizes, for example, can include the following:

Sheets: 12″×12″, 24″×24″;
Rolls: 24″×48″, 24″×96″, 36″×48″, 36″×96″;
Larger or custom sizes available (e.g., upon “special order” request); and/or
Various other sizes can be provided using these techniques (e.g., Sample Sheets: 2″×3″, etc.).

In some implementations, the ‘Peel and Stick’ Pattern System's, Sturdy-Durable Pattern Paper is designed to greatly improve project precision across all phases of Art Glass construction. As any expert will tell you, superior execution begins with a precise pattern throughout all phases of construction. This is because:
Precise pattern-making means accurate cutting
Accurate cutting enables thorough grinding
Thorough grinding forms impeccable foil fitting
Impeccable foil fitting results in expert soldering

‘Peel and Stick’ technology not only makes the pattern-making process more accurate—it's also faster, more flexible, and easier-to-use than traditional, grease pencil, Sharpie, double-sided tape, and paste or spray glue on paper techniques.

Additionally, this flexible pattern paper provides a tolerance for removing/resetting the pattern piece onto the glass a few times, while the adhesive continues to stick and perform well.

The Pattern System reduces the annoying and repetitive work of replacing pattern pieces back-on the glass (which more often comes off during the rigors of cutting, grinding, or sawing processes). The Pattern System also prevents the pattern from getting too moist—a common problem with the standard techniques. Moisture from the grinder (and/or the saw) typically misaligns and even warps the pattern pieces, which requires starting from scratch, redoing the pattern piece over again to ensure precision assembly.

The Pattern System's 9 millimeter Polypropylene Sturdy-Durable Pattern Paper gives the cutter the benefit of a raised edge guideline to follow improving cutting, which also results in less grinding. Improved cutting and grinding accuracy ensures a snug fit during foil-fitting, which minimizes gaps and results in aligning a perfect soldering platform. In all these ways, the Pattern System guides you to far superior results and a more enjoyable process as well.

### Detailed Description of Drawings:

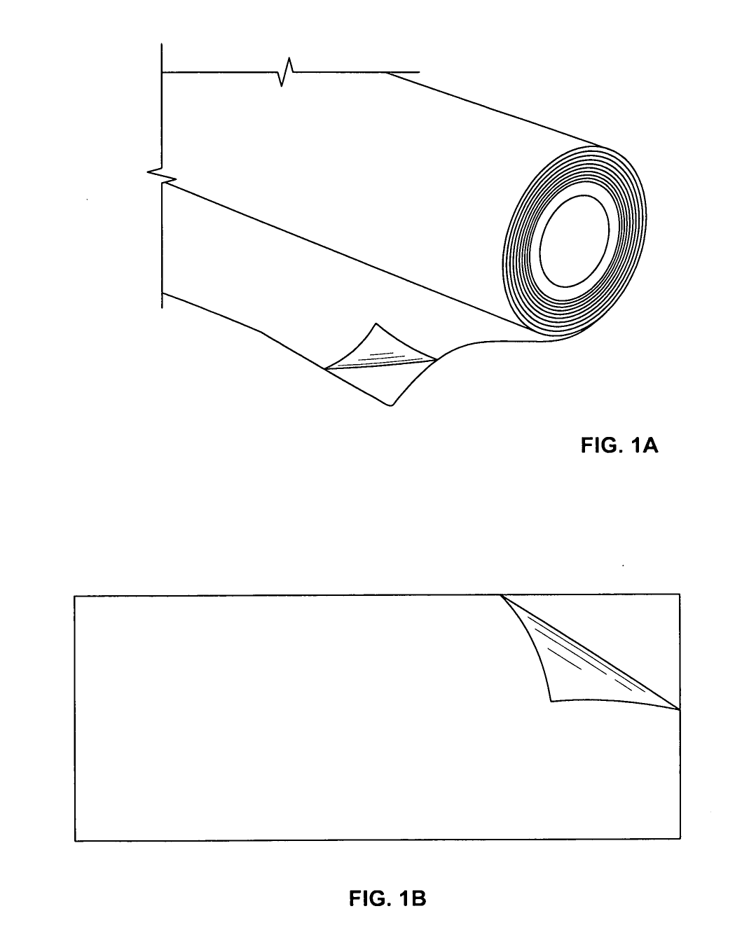

In some embodiments, ‘Peel and Stick’ Pattern Paper is for use directly onto glass surfaces, without using the inferior grease pencil, Sharpie, double-sided tape, and paste or spray glue on paper techniques, etc. For example, ‘Peel and Stick’ Pattern Paper can be provided by the roll or the sheet. (FIGS. 1A & 1B)

### Descriptions of How to Use the ‘Peel and Stick’ Pattern Paper - Art Glass Pattern System:

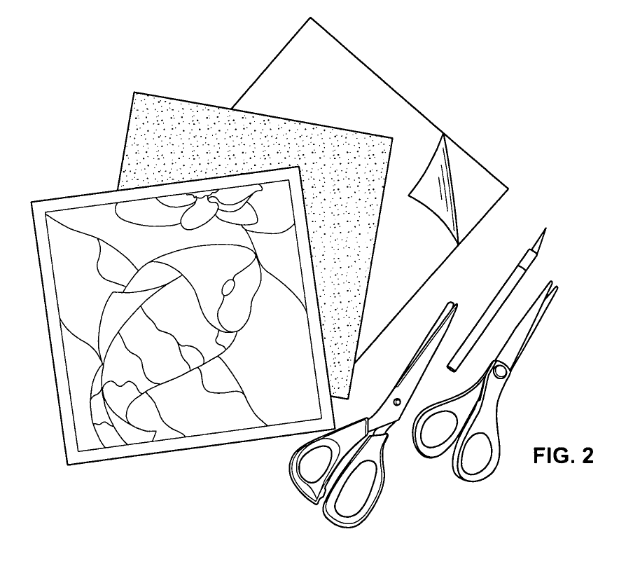

In some embodiments, the ‘Peel and Stick’ pattern paper can be used as described below. Create a copy of the Original Pattern (Cartoon), and transfer it to the ‘Peel and Stick’ Pattern Paper using a Graphite Transfer Paper of choice. (FIG. 2)

### FIG. 2: Art Glass Pattern System Components:

Top sheet; Cartoon of Design
Middle sheet; Graphite Transfer Paper
Bottom sheet; ‘Peel n Stick’ Pattern Paper
Pattern Cutting Tools to pick from; Dual Blade Pattern Shears, Scissors, or Exacto Knife
Additional Tools; Graphite Transfer Paper, Pen, Pencil, or Tracing Wheel (not shown)

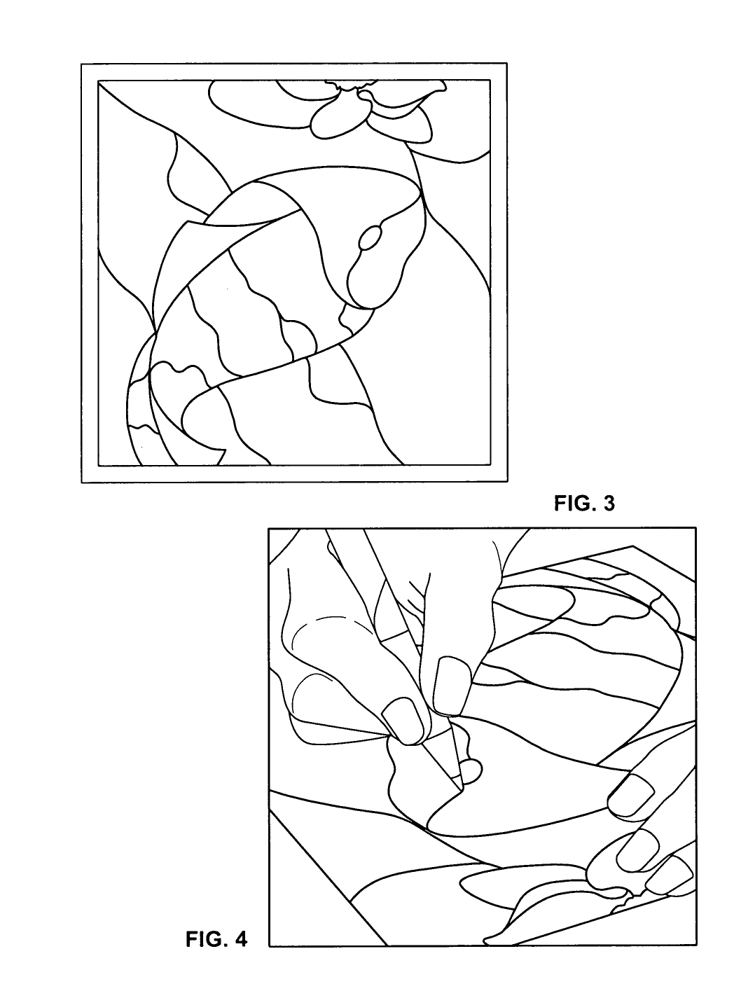

Place Transfer Paper, graphite side down between the cartoon and the ‘Peel and Stick’ Pattern Paper in order to transfer the design image. (FIG. 3)

To transfer the graphite image (cartoon reproduction) to the ‘Peel and Stick’ Pattern Paper, use moderate pressure on your favored tool; a ball point pen, soft pencil, tracing wheel, stylus etc., to trace the image outline of the design through cartoon and transfer paper onto the ‘Peel n Stick’ macro porous coated Pattern Paper. (FIG. 4)

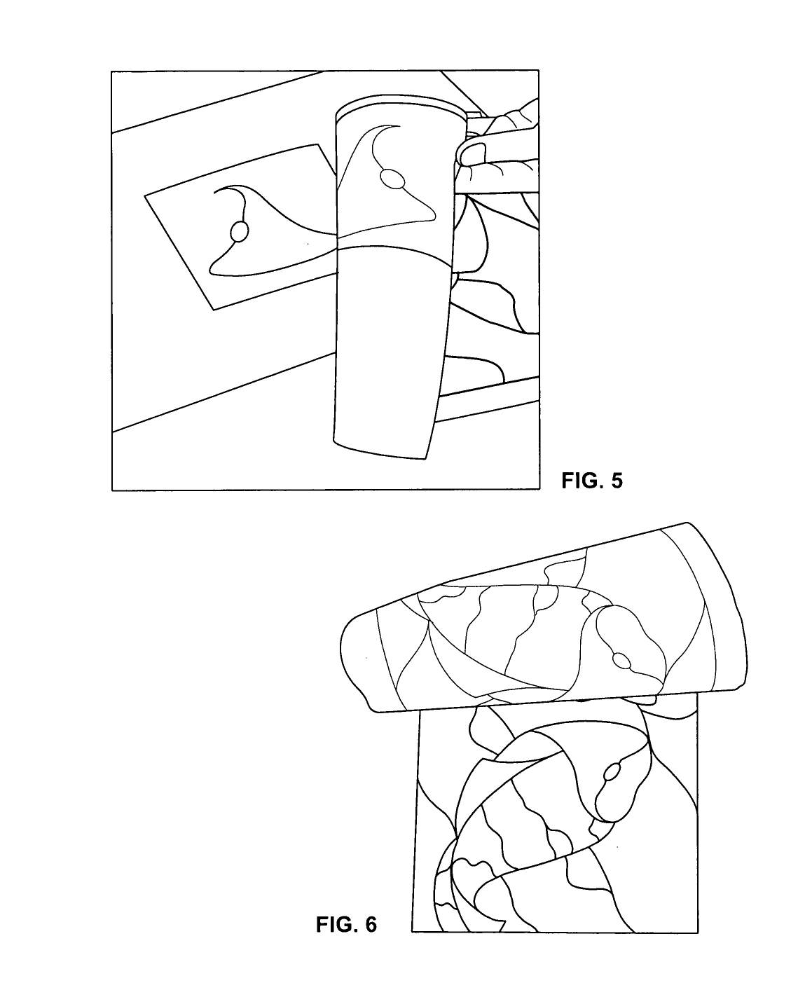

Be sure to apply enough pressure while tracing in order to get the results you desire transferred to the ‘Peel and Stick’ Pattern Paper on the bottom (but avoid too much pressure that might tear the cartoon or graphite paper while tracing transfer). (FIG. 5)

Lift graphite paper carefully to check that ‘all’ cartoon lines have transferred successfully.

(FIG. 6)

Number the corresponding pattern pieces, on the Cartoon and ‘Peel and Stick’ Pattern Paper.

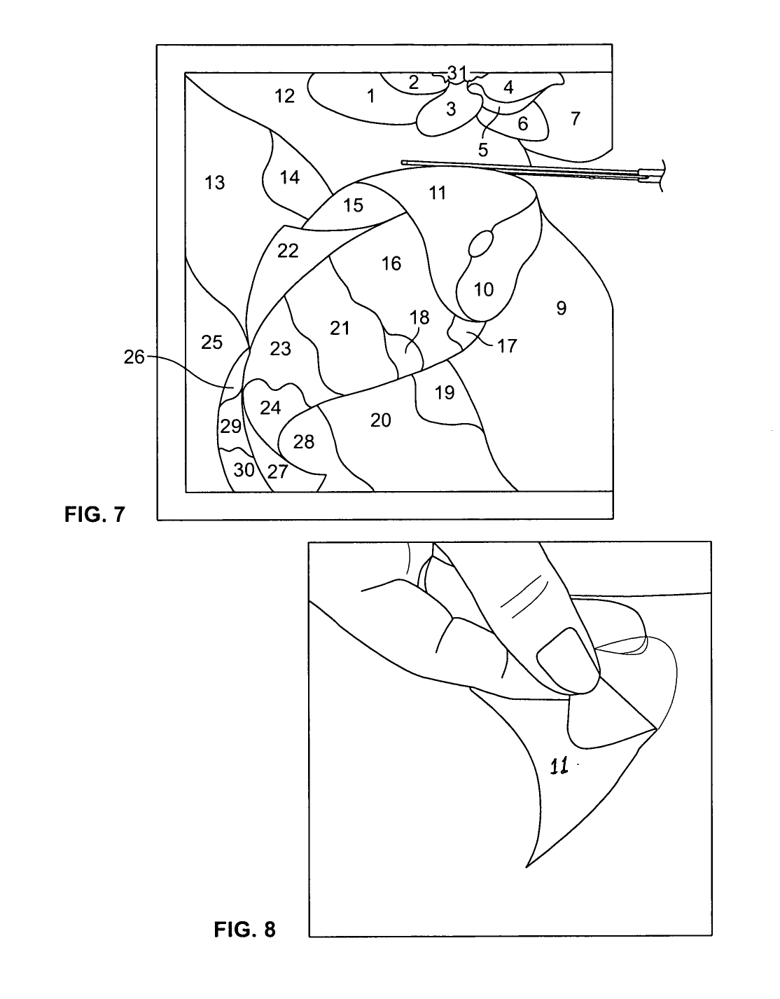

(FIG. 7)

Cut-out ‘Peel and Stick’ Pattern Paper cartoon (design) pieces with the appropriate cutting tool of choice: dual blade pattern shears, dual blade exacto knife or scissors, etc. (FIG. 7)

Peel and stick, cutout cartoon Pattern Paper pieces onto the glass. Impressively, there is some flexibility to lift-off and reset/adjust ‘Peel and Stick’ Pattern Paper pieces if you might change desired placement a few times and it continues to perform (adhere) well . . . while retaining the pattern piece integrity (precise shape). (FIG. 8)

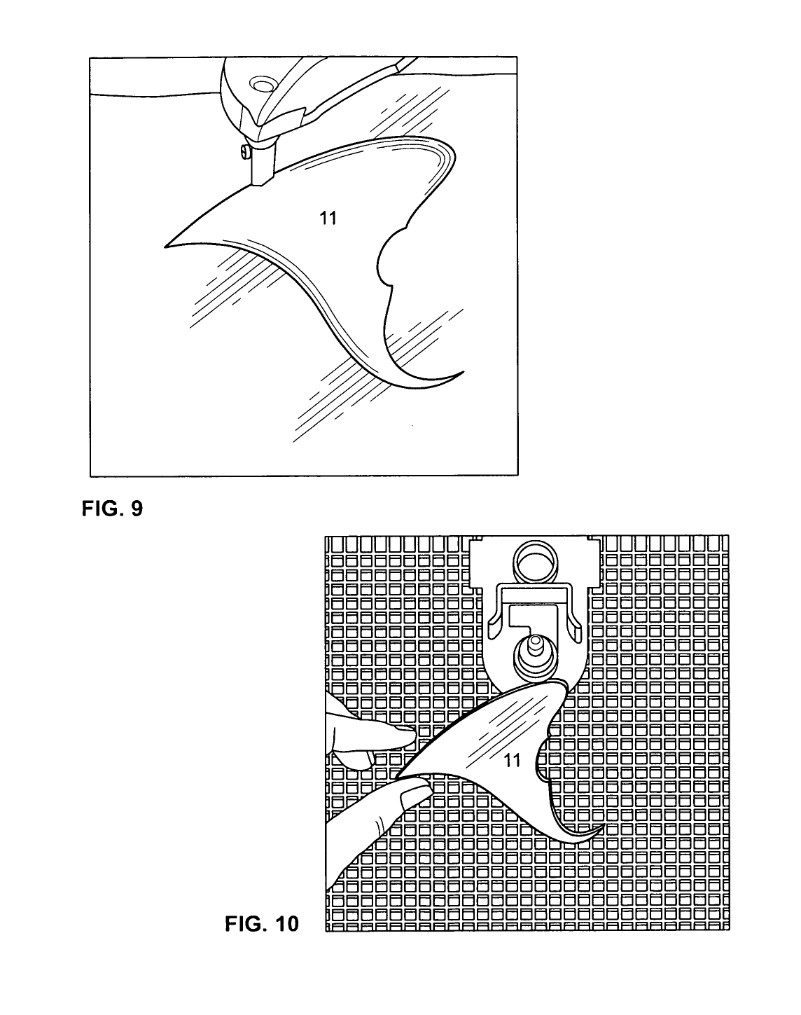

This Sturdy 9 mil macro porous coated ‘Peel and Stick’ Pattern Paper also provides the benefit of a great raised scoring edge working as a guideline, assisting to ensure precision cutting and grinding. (FIG. 9)

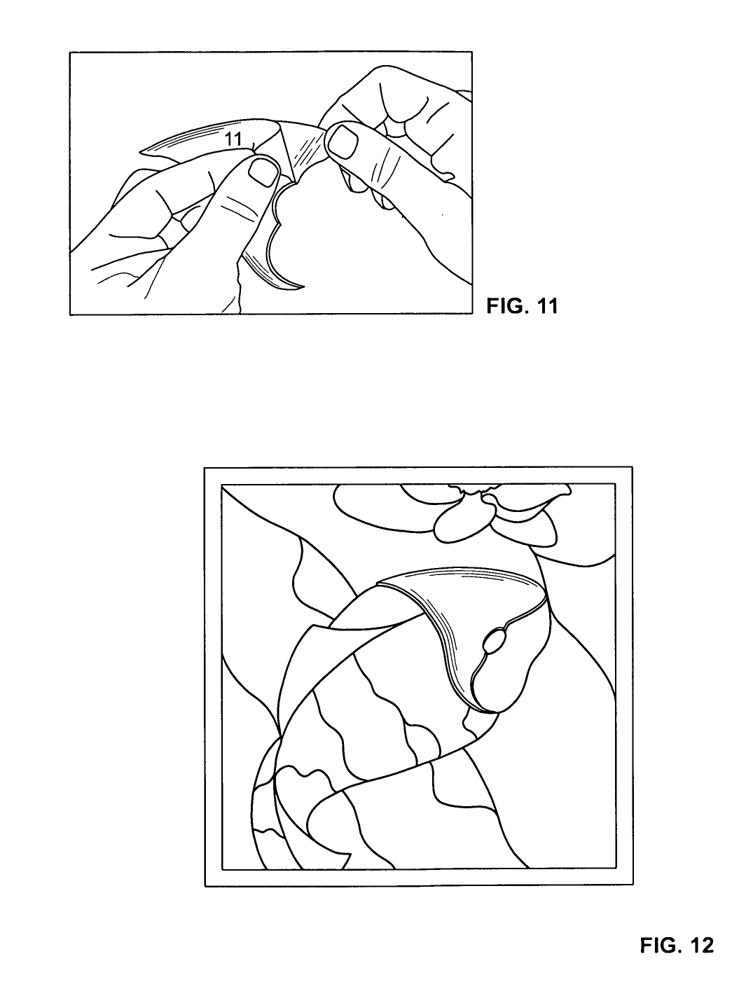

The ‘Peel and Stick’ Pattern Papers' water resistant, durable material is specifically designed to hold-up under harsh cutting and grinding processes, improving cutting accuracy and saving grinding time . . . while contributing to a stable soldering platform. (FIG. 10)

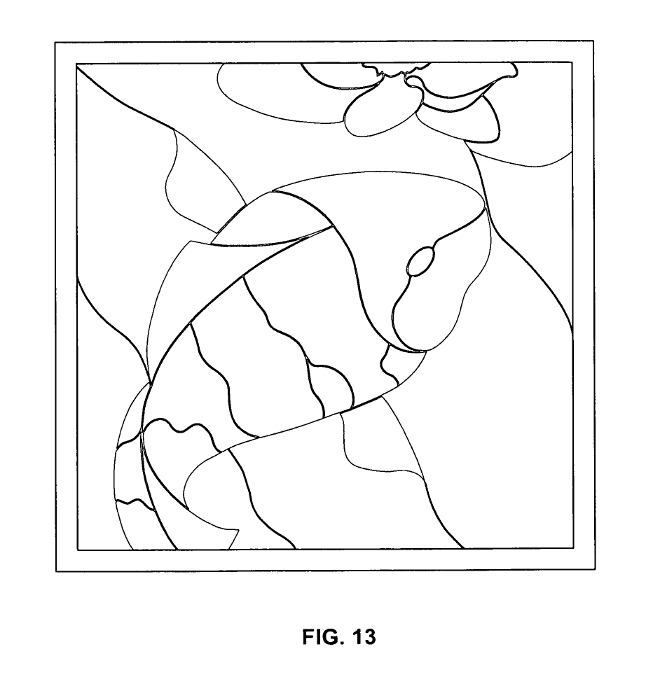

Next, Peel off the “Peel and Stick’ Pattern Paper from the glass piece, if any residue persists you can easily use a moist paper towel or finger to simply roll off the adhesive (similar to rubber cement). (FIG. 11)

Place the cartoon of the original pattern design on construction work surface (this becomes project glass pieces placement guide under the glass project itself). (FIG. 12)

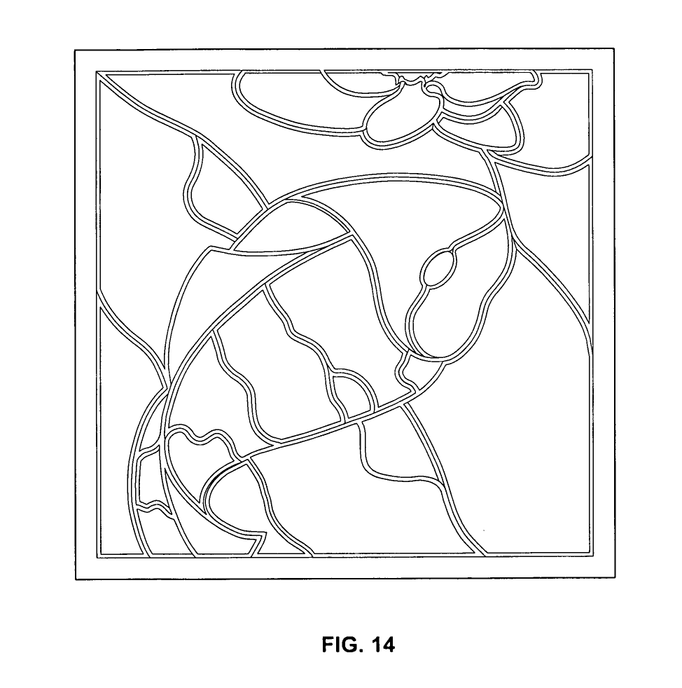

Continue to use the cartoon of the original pattern design as a placement/alignment guide on the construction work surface for the entire project. (FIG. 13)

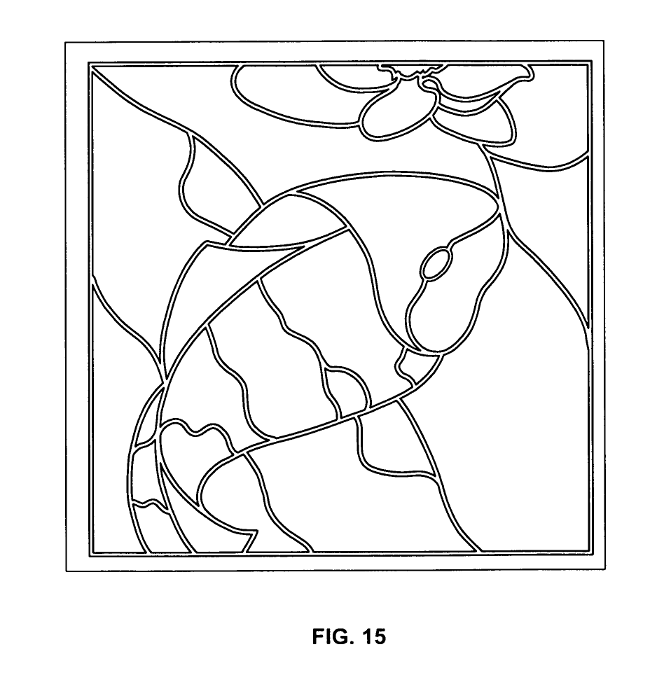

The added precision of the ‘Peel and Stick’ Pattern Papers' accurate/snug-fit results, will improve the platform towards secure foiling onto the glass pieces, greatly minimizing gaps between pieces, which is also, the secret to an ideal soldering platform. (FIG. 14)

The finished project has excellent results of minimal Soldering required with this easy and improved cutting, grinding and foiling accuracy. (FIG. 15)

In some embodiments, Art Glass ‘Peel and Stick’ pattern paper includes the foregoing embodiments have been described in some detail for purposes of clarity of understanding; the invention is not limited to the details provided. There are many alternative ways of implementing the invention. The disclosed embodiments are illustrative and not restrictive.

1. A system for ‘Peel and Stick’ pattern paper comprises of;
a. A first side with a macro porous top coating; and
b. A second side that is a film paper that provides a peel and stick backing, wherein removing the peel from the second side exposes a durable adhesive surface on the first side.

2. The system as recited in claim 1, wherein the macro porous coating comprises of sturdy 9 millimeter macro porous coating with durable adhesive backing.

3. The system as recited in claim 1, wherein the peel-away film paper compromises, 180 gram polypropylene film, protecting adhesive backing during design transfer process.

4. The system as recited in claim 1, wherein the first side comprises a macro porous coating that facilitates a sturdy design surface resulting in accurate cutting and grinding glass pieces.
